(19) United States
(12) Patent Application Publication
(10) Pub. No.: US 2026/0072705 A1
(43) Pub. Date: Mar. 12, 2026

(54) PROGRAM EXECUTION METHODS AND APPARATUSES, STORAGE MEDIA, AND ELECTRONIC DEVICES

(71) Applicant: ALIPAY (HANGZHOU) INFORMATION TECHNOLOGY CO., LTD., Hangzhou (CN)

(72) Inventors: Wuqiong PAN, Hangzhou (CN); Zhongtian QIAN, Hangzhou (CN); Tao WEI, Hanghou (CN); Haonan FENG, Hanghou (CN); Zeming WANG, Hongzhou (CN); Tingting LI, Hangzhou (CN)

(21) Appl. No.: 18/871,783

(22) PCT Filed: Aug. 1, 2023
(86) PCT No.: PCT/CN2023/110631

§ 371 Date: Nov. 19, 2025

(30) Foreign Application Priority Data
Dec. 2, 2022 (CN) 202211543116.0

(51) Int. Cl. G06F 9/448; G06F 9/48; G06F 16/901

(52) U.S. Cl. CPC G06F 9/448; G06F 9/4843; G06F 16/9027

(57) ABSTRACT

This specification discloses program execution methods. In the program execution methods provided in this specification, a corresponding first empty slot is set for each key value determined in a to-be-executed program, and key values are compared. A correspondence between each key value and the first empty slot is redetermined based on a comparison result. The key value is split based on a sum of a quantity of first empty slots and a quantity of second empty slots used to store each key value, to obtain split values. The key value in the to-be-executed program is replaced with the split value, to obtain a split program.

### TECHNICAL FIELD

This specification relates to the computer field, and in particular, to program execution methods and apparatuses, storage media, and electronic devices.

### BACKGROUND

With development of the Internet, privacy and security gradually become core elements of Internet products.

When some programs are executed, related data in the program may be leaked due to execution of the program. For example, when a cyclic operation is executed, a program corresponding to the operation needs to be repeatedly run ten times. Although running data can be encrypted so that an operator cannot directly learn a specific quantity of times that the program needs to be run, the operator can estimate an approximate range of the running data by observing a quantity of running times of the program, and then the quantity of running times of the program is leaked. This reduces data privacy.

Therefore, how to ensure data security during program execution is an urgent problem to be resolved.

### SUMMARY

This specification provides program execution methods and apparatuses, storage media, and electronic devices, to resolve at least a part of the above-mentioned problems.

This specification uses the following technical solutions: This specification provides a program execution method, and the method includes: determining key values in a plurality of to-be-executed programs; for each key value, setting a first empty slot corresponding to the key value; comparing the key value with another key value; redetermining, based on a comparison result, correspondences between first empty slots and the key value; splitting the key value based on a redetermined first empty slot corresponding to the key value, to obtain split values corresponding to the key value, where a sum of the split values is the key value; using a to-be-executed program in which the key value is located as an original program, and for each split value, replacing the key value in the original program with the split value, to obtain a split program corresponding to the original program; and executing split programs corresponding to all to-be-executed programs.

Optionally, the setting a first empty slot corresponding to the key value specifically includes: setting, for the key value, the first empty slot corresponding to the key value and a second empty slot used to store the key value; and the splitting the key value based on a redetermined first empty slot corresponding to the key value specifically includes: splitting the key value based on the redetermined first empty slot corresponding to the key value and the second empty slot used to store the key value.

Optionally, the comparing the key value with another key value specifically includes: using the key values as leaf nodes of a binary tree; using the leaf nodes as to-be-compared nodes; comparing two to-be-compared nodes that have a same parent node, and determining, based on a comparison result, a key value corresponding to the parent node of the two to-be-compared nodes; and reusing the parent node as a to-be-compared node until a key value corresponding to a root node is determined.

Optionally, the determining, based on a comparison result, a key value corresponding to the parent node of the two to-be-compared nodes specifically includes: using a larger value in key values corresponding to the two to-be-compared nodes as the key value corresponding to the parent node of the two to-be-compared nodes.

Optionally, the redetermining correspondences between first empty slots and the key value specifically includes: for each parent node of the binary tree, determining a layer at which a child node of the parent node is located in the binary tree, and determining, based on the layer, a threshold corresponding to the child node of the parent node; and if a ratio of a larger value to a smaller value in key values corresponding to two child nodes of the parent node is not less than the threshold, determining key values corresponding to all leaf nodes included in a subtree corresponding to the parent node in the binary tree as specified key values, and resetting first empty slots corresponding to the specified key values to a key value corresponding to the parent node.

Optionally, the splitting the key value based on the redetermined first empty slot corresponding to the key value and the second empty slot used to store the key value specifically includes: using the first empty slot corresponding to the key value and the second empty slot used to store the key value as available empty slots corresponding to the key value; and splitting, based on a quantity of available empty slots corresponding to the key value, the key value into split values of the quantity, to minimize a difference between the split values split from the key value, where each available empty slot is used to store one split value.

Optionally, before the executing split programs corresponding to all to-be-executed programs, the method further includes: redetermining each split program as a to-be-executed program, and continuing to split a key value in each redetermined to-be-executed program to obtain a corresponding split program until a specified condition is met.

Optionally, that a specified condition is met specifically includes: a difference between key values included in each split program is the minimum; or a quantity of times of redetermining a to-be-executed program reaches a specified quantity of times, where the specified quantity of times is determined based on a maximum value and an average value that are of key values in each initially determined to-be-executed programs.

Optionally, the determining key values in a plurality of to-be-executed programs specifically includes: determining an encrypted key value in the plurality of to-be-executed programs; the comparing the key value with another key value specifically includes: comparing the key value with the another key value by using a confidential operation; the redetermining correspondences between first empty slots and the key value specifically includes: redetermining the correspondences between the first empty slots and the key value by using a confidential operation; and the splitting the key value specifically includes: splitting the key value by using a confidential operation.

This specification provides a program execution apparatus, and the apparatus includes: a determining module, configured to determine key values in a plurality of to-be-executed programs; a processing module, configured to set, for each key value, a first empty slot corresponding to the key value; a comparison module, configured to compare the key value with another key value; a correspondence module, configured to redetermine, based on a comparison result, correspondences between first empty slots and the key value; a splitting module, configured to split the key value based on a redetermined first empty slot corresponding to the key value, to obtain split values corresponding to the key value, where a sum of the split values is the key value; a replacement module, configured to: use a to-be-executed program in which the key value is located as an original program, and replace, for each split value, the key value in the original program with the split value, to obtain a split program corresponding to the original program; and an execution module, configured to execute split programs corresponding to all to-be-executed programs.

This specification provides a non-transitory computer-readable storage medium. The storage medium stores a computer program, and when the computer program is executed by a processor, the program execution method is implemented.

This specification provides an electronic device, including a memory, a processor, and a computer program that is stored in the memory and that is capable of running on the processor. When the processor executes the program, the program execution method is implemented.

The above-mentioned at least one technical solution used in this specification can achieve the following beneficial effects: In the program execution method provided in this specification, a corresponding first empty slot is set for each key value determined in a to-be-executed program, and key values are compared. A correspondence between each key value and the first empty slot is redetermined based on a comparison result. The key value is split based on a sum of a quantity of first empty slots and a quantity of second empty slots used to store each key value, to obtain split values. The key value in the to-be-executed program is replaced with the split value, to obtain a split program.

It can be learned from the above-mentioned method that a plurality of split programs are obtained from the to-be-executed program. Therefore, when a plurality of to-be-executed programs run simultaneously, even if an operator can estimate a total quantity of running times of the programs, the operator cannot learn a specific quantity of running times of a single program. This protects privacy of data.

### BRIEF DESCRIPTION OF DRAWINGS

The accompanying drawings described here are used to provide a further understanding of this specification, and constitute a part of this specification. Example embodiments of this specification and descriptions of the embodiments are used to explain this specification, and do not constitute an inappropriate limitation on this specification. In the accompanying drawings:

FIG. 1 is a schematic flowchart illustrating a program execution method, according to this specification;

FIG. 2 is a diagram illustrating a comparative size relationship between key values, according to this specification;

FIG. 3 is a diagram illustrating that a key value is split into split values, according to this specification;

FIG. 4 is a diagram illustrating a program execution apparatus, according to this specification; and

FIG. 5 is a diagram illustrating an electronic device corresponding to FIG. 1, according to this specification.

### DESCRIPTION OF EMBODIMENTS

A core invention idea of this solution is as follows: Corresponding empty slots are set for key values in a plurality of to-be-executed programs. The key values are compared, and contend for empty slots for splitting. A larger key value indicates more obtained empty slots and a larger quantity of split values obtained through splitting. The key value is split to obtain one or more split values, and the key value in the to-be-executed program is replaced with a split value to obtain a split program. Therefore, a plurality of split programs can be obtained from one to-be-executed program by splitting the key value. When the plurality of to-be-executed programs run simultaneously, even if an operator can estimate a total quantity of running times of the programs, the operator cannot learn a specific quantity of running times of a single program. This protects data security.

To make the objectives, technical solutions, and advantages of this specification clearer, the following clearly and comprehensively describes the technical solutions of this specification with reference to specific embodiments and accompanying drawings of this specification. Clearly, the described embodiments are merely some but not all of the embodiments of this specification. All other embodiments obtained by a person of ordinary skill in the art based on embodiments of this specification without creative efforts shall fall within the protection scope of this specification.

The following describes in detail the technical solutions provided in the embodiments of this specification with reference to the accompanying drawings.

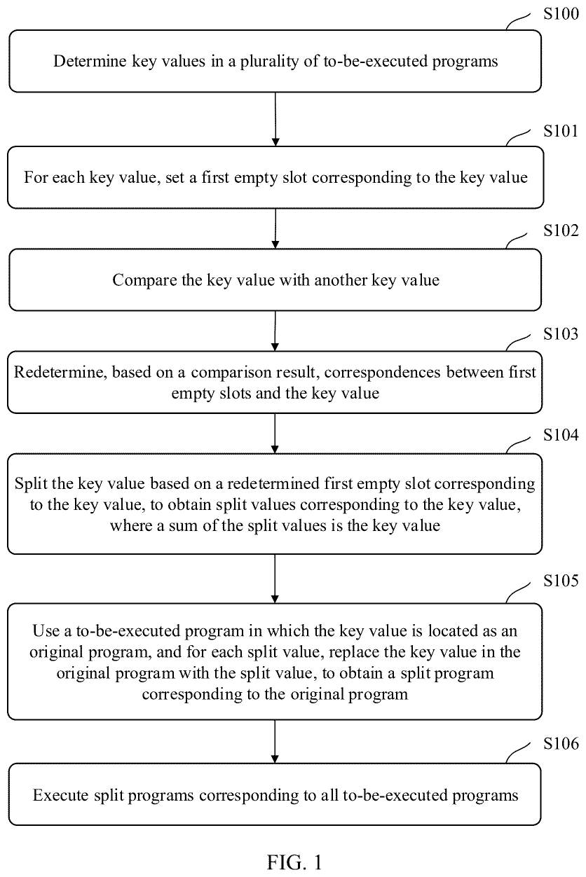

FIG. 1 is a schematic flowchart illustrating a program execution method, according to this specification, and specifically includes the following steps S100 to S106.
S100: Determine key values in a plurality of to-be-executed programs.

The program provided in this specification can be executed by a server, or can be executed by an electronic device like a personal computer (PC) or a mobile phone. For ease of description, the following only uses a server as an execution body to describe the program execution method provided in this specification.

In embodiments of this specification, a key value refers to a value that is private but may be leaked during program running. For example, a to-be-executed program is used for a replication operation, and a quantity of replication times is not expected to be learned by an operator. To complete the operation, the to-be-executed program needs to be run 10 times, Although a quantity “10” of cyclical execution times in the to-be-executed program can be encrypted, once a server starts to execute the to-be-executed program, the operator can estimate a quantity of replication times by observing running of the to-be-executed program, where 10 is a key value of the to-be-executed program.

The program execution method in this specification is applied to a scenario in which a plurality of to-be-executed programs are executed simultaneously, and a quantity of key values in each to-be-executed program is uncertain, and can be one or more. Therefore, the following content is described by using one key value in a plurality of key values as an example.
S101: For each key value, set a first empty slot corresponding to the key value.

After the key value is determined from the to-be-executed program, a corresponding first empty slot is set for the key value, and the first empty slot is used to store split values of the key value. The first empty slot refers to storage space, and each first empty slot can store only one split value. After the first empty slot is set, the key value is compared with another key value, and a first empty slot corresponding to the key value is redistributed based on a comparison result. A larger key value indicates a larger quantity of first empty slots distributed to the key value.
S102: Compare the key value with another key value.

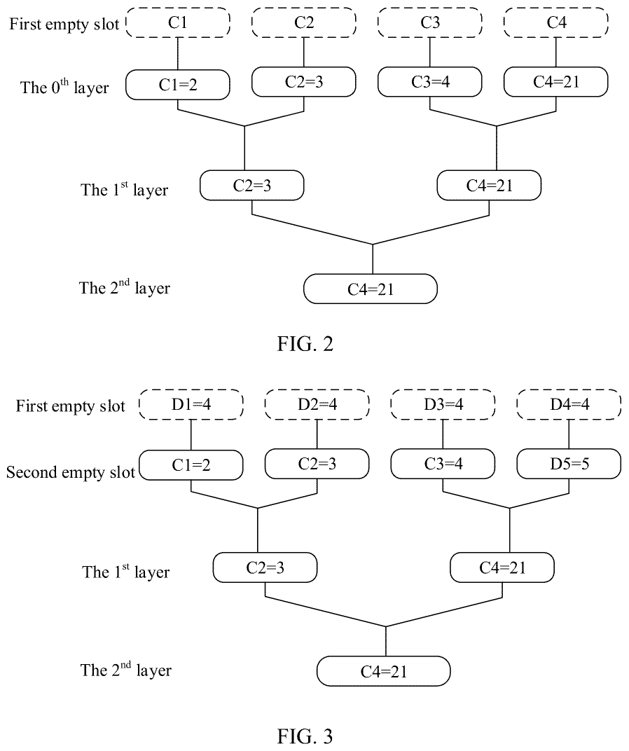

After the first empty slot is allocated to the key value, the key value is compared with the another key value. Specifically, key values can be compared by using a binary tree. The key values are used as leaf nodes, the leaf nodes are used as to-be-compared nodes, and two to-be-compared nodes that have a same parent node are compared. A larger value in key values corresponding to the two to-be-compared nodes is used as a key value corresponding to the parent node of the two to-be-compared nodes, and the parent node is reused as a to-be-compared node until a key value corresponding to a root node is determined, as shown in FIG. 2.

In FIG. 2, c1, c2, c3, and c4 are key values in four to-be-executed programs. First, corresponding first empty slots are set for c1, c2, c3, and c4. Then, c1, c2, c3, and c4 are compared, and the four key values are used as leaf nodes (namely, four leaf nodes at the 0 ^{th} layer in FIG. 2). Each leaf node is used as a to-be-compared node, and two leaf nodes that have a same parent node are compared. For example, c1 and c2 are compared, and c3 and c4 are compared. The larger one in c1 and c2 is used as a key value corresponding to a parent node of c1 and c2. For example, c2 is 3, c1 is 2, and c2 is greater than c1. In this case, the key value corresponding to the parent node of c1 and c2 is c2-3. This is applicable to c3 and c4. A parent node of c3 and c4 (namely, two nodes at the 1^{st} layer in FIG. 2) is reused as a to-be-compared node until a key value corresponding to a root node is determined. For example, c2 and c4 are compared again, and the larger one c4 is used as a parent node of c2 and c4. In other words, c4 is a root node (namely, a root node at the 2^{nd} layer in FIG. 2) of the binary tree.
S103: Redetermine, based on a comparison result, correspondences between first empty slots and the key value.

A layer of a binary tree at which child nodes that have a same parent node are located is determined, to determine a threshold corresponding to the child nodes. Child nodes at a same layer have a same threshold, and a threshold of each layer is 2ⁱ, where i is the layer of the binary tree.

If a ratio of key values of the two to-be-compared nodes is not less than a threshold corresponding to the two to-be-compared nodes, key values corresponding to all leaf nodes included in a subtree corresponding to the parent node in the binary tree are determined as specified key values, and first empty slots corresponding to the specified key values are reset to a key value corresponding to the parent node.

If a ratio of key values of the two to-be-compared nodes is less than a threshold corresponding to the two to-be-compared nodes, correspondences between all leaf nodes included in a subtree corresponding to the parent node in the binary tree and the first empty slot are maintained.

In FIG. 2, a threshold is related to a layer, and nodes at a same layer have the same threshold. Therefore, a threshold of the 1^{st} layer is 2¹=2, and a ratio of c1 to c2 is less than the threshold 2 of the layer. Therefore, c1 and c2 do not contend for the first empty slot, and an original correspondence is maintained. A ratio of c3 to c4 is greater than the threshold 2 of the layer. In this case, c4 contends for the first empty slot of c3, so that c4 obtains more split opportunities. Similarly, the two parent nodes c2 and c4 continue to be compared. In this case, the threshold changes with the layer, and a threshold of the 2^{nd} layer is 2²=4, A ratio of c4 to c2 is greater than the threshold 4 of the layer. In this case, c4 contends for first empty slots of all leaf nodes included in a subtree corresponding to c2 in the binary tree. Finally, the first empty slots corresponding to c1, c2, and c3 are all provided for c4 for splitting, and c4 corresponds to the first empty slots originally set for c1, c2, c3, and c4.
S104: Split the key value based on a redetermined first empty slot corresponding to the key value, to obtain split values corresponding to the key value, where a sum of the split values is the key value.

In S101, when the first empty slot is set, a second empty slot used to store the key value is set, and the second empty slot is also storage space. One second empty slot stores only one key value. A quantity of available empty slots of the key value is determined based on correspondences between the redetermined first empty slots and the key value. The available empty slots are a sum of a quantity of the second empty slots and a quantity of redistributed first empty slots. The key value is split into split values of the quantity based on the quantity of available empty slots corresponding to the key value, so that a difference between the split values split from the key value is the minimum, in other words, the obtained split values are as even as possible. Each available empty slot is used to store one split value, and a specific quantity of the available empty slots indicates a specific quantity of split values split from the key value. A sum of the split values is equal to the key value.

In FIG. 3, it can be learned, based on the correspondences between the redetermined first empty slots and the key value, that c1, c2, and c3 all provide the first empty slots corresponding to c1, c2, and c3 for c4 for splitting. Second empty slots of c1, c2, and c3 are respectively used to store c1, c2, and c3, and therefore are not provided for c4 to use. Therefore, empty slots of c4 that can be used for splitting include the first empty slots originally corresponding to c1, c2, and c3, the first empty slot corresponding to c4, and a second empty slot that stores c4. A quantity of available empty slots is 5. Therefore, c4=21 is evenly split into five split values to obtain D1=4, D2=4, D3=4, D4=4, and D5=5.
S105: Use a to-be-executed program in which the key value is located as an original program, and for each split value, replace the key value in the original program with the split value, to obtain a split program corresponding to the original programs.

The key value in the original program is replaced with the split value obtained by splitting the key value, and a plurality of split programs can be determined by using one original program, so that when a plurality of to-be-executed programs run, even if a total quantity of running times of the programs can be estimated, a specific quantity of running times of a single program cannot be learned. Therefore, data security is effectively protected.

In FIG. 3, a to-be-executed program in which c4 is located is used as an original program, c4 in the original program is replaced with D1, D2, D3, D4, and DS separately to obtain corresponding split programs, the key value is replaced with five split values to obtain five split programs, four original to-be-executed programs are changed to three to-be-executed programs and five split programs, and a total quantity of programs is changed from four to
S106: Execute split programs corresponding to all to-be-executed programs.

In the program execution method provided in this specification, a corresponding first empty slot is set for each key value determined in a to-be-executed program, and key values are compared. A correspondence between each key value and the first empty slot is redetermined based on a comparison result, and a larger key value indicates a larger quantity of redetermined first empty slots corresponding to the key value. The key value is split based on a sum of a quantity of first empty slots and a quantity of second empty slots used to store the key values, to obtain split values. The key value in the to-be-executed program is replaced with the split value, to obtain a split program, so that a plurality of split programs can be obtained from one to-be-executed program by splitting the key value. Therefore, when a plurality of to-be-executed programs run simultaneously, even if an operator can estimate a total quantity of running times of the programs, the operator cannot learn a specific quantity of running times of a single program. This resolves a problem of leaking privacy sensitive values during program running, and protects data security.

In embodiments of this specification, the above-mentioned method is used to split a key value into split values with a minimum difference instead of directly evenly splitting the key values. The reason is that an operator can observe an action of evenly splitting the key value into a plurality of split values, and therefore can learn a specific quantity of split values that the key value is evenly split into, that is, a range of the key value can be estimated. Therefore, a method of evenly splitting the key value cannot ensure data security. To ensure data security, a sorting method can alternatively be used to split a key value, that is, key values are sorted in a descending order, and key values ranking top n are split. Then, split values obtained through splitting and key values that are not split are sorted again, and the splitting continues. However, in this method, full sorting needs to be performed each time splitting is performed, and a sorting operation consumes large computing resources and is inefficient in a computer. Therefore, in this specification, a binary tree is used to compare the key values and split the key values into split values with a minimum difference. This can not only improve efficiency, but also ensure data security.

In FIG. 3, corresponding first empty slots are respectively set for key values c1, c2, c3, and c4 that are determined from the four to-be-executed programs, and c1, c2, c3, and c4 are compared. It can be determined, based on a comparison result, that c1, c2, and c3 provide the first empty slots of c1, c2, and c3 for c4 to use. Finally, c4 has five available empty slots, and is split into five split values D1, D2, D3, D4, and D5 that are as even as possible. The split values are replaced with key values to obtain five corresponding split programs. The above-mentioned operations are all completed in an encrypted state, and the four to-be-executed programs are changed to eight to-be-executed programs, so that the operator cannot learn a specific key value that is split and a quantity of splitting times of the split key value. Therefore, when a plurality of to-be-executed programs run simultaneously, even if the operator can learn a total quantity of running times of the programs, the operator cannot learn a specific quantity of running times of a single program. This protects data security.

In embodiments of this specification, the key values are determined in an encrypted state, that is, the key values are invisible to the operator. The key values are compared by using a confidential operation, and a correspondence between the first empty slot and the key value is redetermined based on a comparison result. In addition, splitting of the key value is also performed by using a confidential operation. If the above-mentioned operation is performed in a non-encrypted state, the operator can estimate a size of the key value by observing a quantity of running times and a quantity of splitting times of a to-be-executed program in a plurality of to-be-executed programs. Therefore, the above-mentioned operation needs to be performed in an encrypted method to ensure data security.

Whether the plurality of to-be-executed programs in embodiments of this specification are split is determined based on a comparison result of the key values, and the plurality of to-be-executed programs may be split or may not be split. Therefore, to further ensure data security, key values of split programs obtained through splitting and key values of unsplit to-be-executed programs need to be as even as possible. In a procedure shown in FIG. 1, before step S106, after split programs are obtained based on split values, the split programs are redetermined as to-be-executed programs in step S100 until key values included in the split programs are as even as possible, that is, the splitting can be stopped when a difference between the key values included in the split programs is the minimum or a quantity of times of redetermining the to-be-executed program reaches a specified quantity of times. The specified quantity of times is a ratio of a maximum value and an average value that are of key values in each initially determined to-be-executed program.

Split programs with even key values obtained after a to-be-executed program with a large key value is split are compared with the unsplit to-be-executed programs that are used as to-be-executed programs again, and splitting is performed, so that key values of finally-determined programs are even. This further ensures data security during program running.

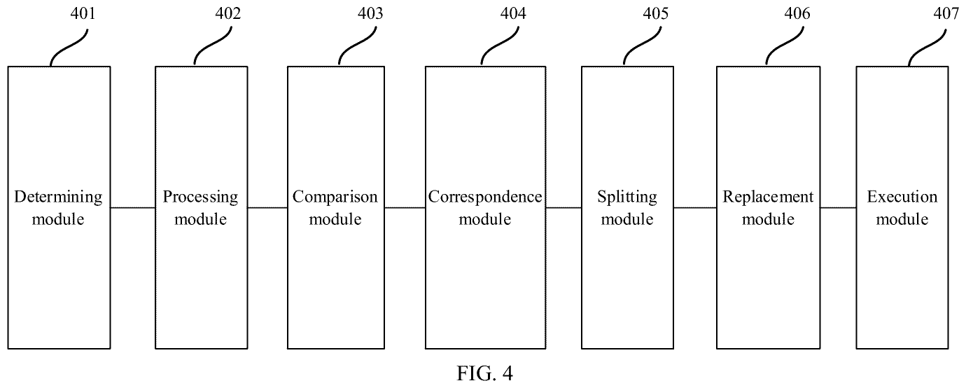

The program execution method provided in one or more embodiments of this specification is described above. Based on the same idea, this specification further provides a corresponding program execution apparatus, as shown in FIG. 4.

FIG. 4 is a diagram illustrating a program execution apparatus, according to this specification, and specifically includes: a determining module 401, configured to determine key values in a plurality of to-be-executed programs; a processing module 402, configured to set, for each key value, a first empty slot corresponding to the key value; a comparison module 403, configured to compare the key value with another key value; a correspondence module 404, configured to redetermine, based on a comparison result, correspondences between first empty slots and the key value; a splitting module 405, configured to split the key value based on a redetermined first empty slot corresponding to the key value, to obtain split values corresponding to the key value, where a sum of the split values is the key value; a replacement module 406, configured to: use a to-be-executed program in which the key value is located as an original program, and replace, for each split value, the key value in the original program with the split value, to obtain a split program corresponding to the original program; and an execution module 407, configured to execute split programs corresponding to all to-be-executed programs.

Optionally, the processing module 402 is specifically configured to set, for the key value, the first empty slot corresponding to the key value and a second empty slot used to store the key value. The splitting module 405 is specifically configured to split the key value based on the redetermined first empty slot corresponding to the key value and the second empty slot used to store the key value.

Optionally, the comparison module 403 is specifically configured to: use the key values as leaf nodes of a binary free; use the leaf nodes as to-be-compared nodes; compare two to-be-compared nodes that have a same parent node, and determine, based on a comparison result, a key value corresponding to the parent node of the two to-be-compared nodes; and reuse the parent node as a to-be-compared node until a key value corresponding to a root node is determined.

Optionally, the comparison module 403 is specifically configured to use a larger value in key values corresponding to the two to-be-compared nodes as the key value corresponding to the parent node of the two to-be-compared nodes.

Optionally, the correspondence module 404 is specifically configured to: for each parent node of the binary tree, determine a layer at which a child node of the parent node is located in the binary tree, and determine, based on the layer, a threshold corresponding to the child node of the parent node; and if a ratio of a larger value to a smaller value in key values corresponding to two child nodes of the parent node is not less than the threshold, determine key values corresponding to all leaf nodes included in a subtree corresponding to the parent node in the binary tree as specified key values, and reset first empty slots corresponding to the specified key values to a key value corresponding to the parent node.

Optionally, the splitting module 405 is specifically configured to: use the first empty slot corresponding to the key value and the second empty slot used to store the key value as available empty slots corresponding to the key value; and split, based on a quantity of available empty slots corresponding to the key value, the key value into split values of the quantity, to minimize a difference between the split values split from the key value, where each available empty slot is used to store one split value.

Optionally, the splitting module 405 is specifically configured to: before executing split programs corresponding to all to-be-executed programs, redetermine each split program as a to-be-executed program, and continue to split a key value in each redetermined to-be-executed program to obtain a corresponding split program until a specified condition is met.

Optionally, that a specified condition is met specifically includes: a difference between key values included in each split program is the minimum; or a quantity of times of redetermining a to-be-executed program reaches a specified quantity of times, where the specified quantity of times is determined based on a maximum value and an average value that are of key values in each initially determined to-be-executed program.

Optionally, the determining module 401 is specifically configured to determine an encrypted key value in the plurality of to-be-executed programs; the comparison module 403 is specifically configured to compare the key value with the another key value by using a confidential operation; the correspondence module 404 is specifically configured to redetermine the correspondences between the first empty slots and the key value by using a confidential operation; and the splitting module 405 is specifically configured to split the key value by using a confidential operation.

This specification further provides a computer-readable storage medium. The storage medium stores a computer program, and the computer program can be used to perform the program execution method provided in FIG. 1.

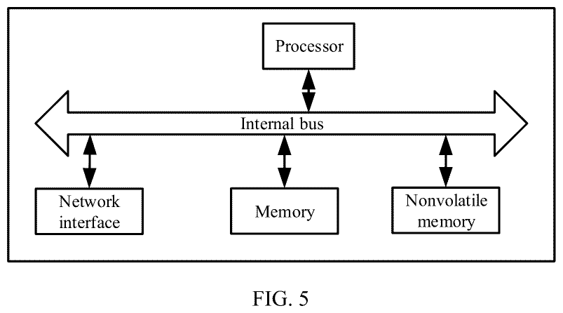

This specification further provides a structural diagram illustrating an electronic device shown in FIG. 5. As shown in FIG. 5, in terms of hardware, the electronic device includes a processor, an internal bus, a network interface, a memory, and a nonvolatile memory, and certainly may further include hardware needed by another service. The processor reads a corresponding computer program from the nonvolatile memory into the memory and then runs the computer program, to implement the program execution method shown in FIG. 1. Certainly, in addition to software implementations, another implementation is not excluded in this specification, for example, a logic device or a combination of hardware and software, In other words, an execution body of the following processing process is not limited to logical units, and can be hardware or a logic device.

In the 1990s, whether a technical improvement is a hardware improvement (for example, an improvement to a circuit structure, like a diode, a transistor, or a switch) or a software improvement (an improvement to a method procedure) can be clearly distinguished. However, with development of technologies, an improvement to many existing method procedures can be considered as a direct improvement to hardware circuit structures. A designer usually programs an improved method procedure to a hardware circuit, to obtain a corresponding hardware circuit structure. Therefore, a method procedure can be improved by using a hardware entity module. For example, a programmable logic device (PLD) (for example, a field programmable gate array (FPGA)) is such an integrated circuit, and a logical function of the PLD is determined by a user through device programming. The designer performs programming to “integrate” a digital system to a PLD without requesting a chip manufacturer to design and manufacture an application-specific integrated circuit chip. In addition, instead of making an integrated circuit chip manually today, this programming is mostly implemented by using “logic compiler” software. It is similar to the software compiler used in program development and writing. The original code to be compiled before is also written in a specific programming language. This is referred to as a hardware description language (HDL), and HDL is not only one, but also many, such as ABEL (Advanced Boolean Expression Language), AHDL (Altera Hardware Description Language), Confluence, CUPL (Cornell University Programming Language), HDCal, JHDL (Java Hardware Description Language), Lava, Lola, MyHDL, PALASM, and RHDL (Ruby Hardware Description Language). Currently, VHDL (Very-High-Speed Integrated Circuit Hardware Description Language) and Verilog are most commonly used. It should also be clear to a person skilled in the art that a hardware circuit that implements a logical method procedure can be readily obtained once the method procedure is logically programmed by using the several hardware description languages described above and is programmed into an integrated circuit.

A controller can be implemented in any suitable way. For example, the controller can be in a form like a microprocessor, a processor, or a computer-readable medium, a logic gate, a switch, an application-specific integrated circuit (ASIC), a programmable logic controller, or an embedded microcontroller storing computer-readable program code (for example, software or firmware) that can be executed by the (micro)processor. Examples of the controller include but are not limited to the following microcontrollers: ARC 625D, Atmel AT91SAM, Microchip PIC18F26K20, and Silicone Labs C805IF320. A storage controller can also be implemented as a part of control logic of the storage. A person skilled in the art also knows that in addition to implementing the controller by using only the computer-readable program code, logic programming can be performed on method steps to enable the controller to implement the same function in a form of a logic gate, a switch, an application-specific integrated circuit, a programmable logic controller, or an embedded microcontroller. Therefore, the controller can be considered as a hardware component, and an apparatus configured to implement various functions in the controller can also be considered as a structure in the hardware component. Alternatively, an apparatus configured to implement various functions can be considered as a software module implementing a method or a structure in a hardware component.

The systems, apparatuses, modules, or units described in the above-mentioned embodiments can be specifically implemented by a computer chip or an entity, or can be implemented by a product having a certain function. A typical implementation device is a computer. Specifically, for example, the computer can be a personal computer, a laptop computer, a cellular phone, a camera phone, a smartphone, a personal digital assistant, a media player, a navigation device, an email device, a game console, a tablet computer, a wearable device, or a combination of any of these devices.

For ease of description, the above-mentioned apparatus is described by dividing functions into various units. Certainly, during implementation of this specification, functions of units can be implemented in the same or more software or hardware.

A person skilled in the art should understand that the embodiments of this specification can be provided as methods, systems, or computer program products. Therefore, a form of hardware only embodiments, software only embodiments, or embodiments with a combination of software and hardware can be used in this specification. In addition, a form of a computer program product that is implemented on one or more computer-usable storage media (including but not limited to a disk storage, a CD-ROM, an optical storage, etc.) that include computer-usable program code can be used in this specification.

This specification is described with reference to a flowchart and/or block diagram of a method, a device (system), and a computer program product according to embodiments of this specification. It should be understood that computer program instructions can be used to implement each procedure and/or each block in the flowcharts and/or the block diagrams and a combination of a procedure and/or a block in the flowcharts and/or the block diagrams. These computer program instructions can be provided for a general-purpose computer, a dedicated computer, an embedded processor, or a processor of any other programmable data processing device to generate a machine, so that the instructions executed by a computer or a processor of any other programmable data processing device generate an apparatus for implementing a specific function in one or more procedures in the flowcharts and/or in one or more blocks in the block diagrams.

These computer program instructions can alternatively be stored in a computer-readable memory that can indicate a computer or another programmable data processing device to work in a specific way, so that an instruction stored in the computer-readable memory generates a manufacturer including an instruction apparatus, and the instruction apparatus implements a function specified in one or more procedures of a flowchart and/or one or more blocks of a block diagram.

These computer program instructions can alternatively be loaded onto a computer or another programmable data processing device, so that a series of operations and steps are performed on the computer or the another programmable device to generate computer-implemented processing. Therefore, the instructions executed on the computer or the another programmable device provide steps for implementing a specific function in one or more procedures in the flowcharts and/or in one or more blocks in the block diagrams.

In a typical configuration, a computing device includes one or more processors (CPUs), one or more input/output interfaces, one or more network interfaces, and one or more memories.

The memory may include a form like a non-permanent memory, a random access memory (RAM), or a nonvolatile memory in a computer-readable medium, for example, a read-only memory (ROM) or a flash memory (flash RAM). The memory is an example of the computer-readable medium.

Computer-readable media, including permanent and non-permanent, removable and non-removable media, can be implemented by any method or technology for information storage. The information can be computer-readable instructions, a data structure, a program module, or other data. Examples of the computer storage medium include but are not limited to a phase change random access memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a cassette magnetic tape, a magnetic tape/magnetic disk storage, another magnetic storage device, or any other non-transmission medium. The computer storage medium can be configured to store information that can be accessed by a computing device. Based on the definition in this specification, the computer-readable medium does not include transitory media such as a modulated data signal and carrier.

Further notably, the terms “include”, “comprise”, or any other variants are intended to cover a non-exclusive inclusion, so that a process, a method, a product, or a device that includes a list of elements not only includes those elements but also includes other elements that are not expressly listed, or further includes elements inherent to such s process, method, product, or device. Without more constraints, an element preceded by “includes a.” does not preclude the presence of additional identical elements in the process, method, product, or device that includes the element.

A person skilled in the art should understand that the embodiments of this specification can be provided as methods, systems, or computer program products. Therefore, a form of hardware only embodiments, software only embodiments, or embodiments with a combination of software and hardware can be used in this specification. In addition, a form of a computer program product that is implemented on one or more computer-usable storage media (including but not limited to a disk storage, a CD-ROM, an optical storage, etc.) that include computer-usable program code can be used in this specification.

This specification can be described in a general context of computer-executable instructions executed by a computer, for example, a program module. Generally, the program module includes a routine, a program, an object, a component, a data structure, etc. for executing a specific task or implementing a specific abstract data type. This specification can alternatively be practiced in distributed computing environments. In the distributed computing environments, tasks are executed by remote processing devices connected through a communication network. In the distributed computing environment, a program module can be located in local and remote computer storage media including a storage device.

The embodiments of this specification are described in a progressive way. For same or similar parts in the embodiments, refer to each other. Each embodiment focuses on a difference from other embodiments. Particularly, the system embodiment is basically similar to the method embodiment, and therefore is briefly described. For a related part, refer to some descriptions in the method embodiment.

The above-mentioned content is merely embodiments of this specification, and is not intended to limit this specification. A person skilled in the art can make various changes and variations to this specification. Any modification, equivalent replacement, or improvement made without departing from the spirit and principle of this specification shall fall within the scope of the claims in this specification.

1. A program execution method, wherein the method comprises:
determining key values in a plurality of to-be-executed programs;
for each key value, setting a first empty slot corresponding to a key value;
comparing the key value with another key value;
redetermining, based on a comparison result, correspondences between each first empty slot and the key value;
splitting the key value based on a redetermined first empty slot corresponding to the key value, to obtain each split value corresponding to the key value, wherein a sum of each split value is the key value;
using a to-be-executed program in which the key value is located as an original program, and for each split value, replacing the key value in the original program with the split value, to obtain a split program corresponding to the original program; and
executing split programs corresponding to all to-be-executed programs.

2. The method according to claim 1, wherein the setting a first empty slot corresponding to a key value comprises:
setting, for the key value, the first empty slot corresponding to the key value and a second empty slot used to store the key value; and
the splitting the key value based on a redetermined first empty slot corresponding to the key value comprises:
splitting the key value based on the redetermined first empty slot corresponding to the key value and the second empty slot used to store the key value.

3. The method according to claim 1, wherein the comparing the key value with another key value comprises:
using the key values as leaf nodes of a binary tree;
using each leaf node of the leaf nodes as a to-be-compared node;
comparing two to-be-compared nodes that have a same parent node, and determining, based on a comparison result, a key value corresponding to the parent node of the two to-be-compared nodes; and
reusing the parent node as the to-be-compared node until a key value corresponding to a root node is determined.

4. The method according to claim 3, wherein the determining, based on a comparison result, a key value corresponding to the parent node of the two to-be-compared nodes comprises:
using a larger value in key values corresponding to the two to-be-compared nodes as the key value corresponding to the parent node of the two to-be-compared nodes.

5. The method according to claim 3, wherein the redetermining correspondences between each first empty slot and the key value comprises:
for each parent node of the binary tree, determining a layer at which a child node of the parent node is located in the binary tree, and determining, based on the layer, a threshold corresponding to the child node of the parent node; and
if a ratio of a larger value to a smaller value in key values corresponding to two child nodes of the parent node is not less than the threshold, determining key values corresponding to all leaf nodes comprised in a subtree corresponding to the parent node in the binary tree as specified key values, and resetting first empty slots corresponding to the specified key values to a key value corresponding to the parent node.

6. The method according to claim 2, wherein the splitting the key value based on the redetermined first empty slot corresponding to the key value and the second empty slot used to store the key value comprises:
using the first empty slot corresponding to the key value and the second empty slot used to store the key value as available empty slots corresponding to the key value; and
splitting, based on a quantity of available empty slots corresponding to the key value, the key value into split values of the quantity, to minimize a difference between the split values split from the key value, wherein each available empty slot is used to store one split value.

7. The method according to claim 1, wherein before the executing split programs corresponding to all to-be-executed programs, the method further comprises:
redetermining each split program as a to-be-executed program, and continuing to split a key value in each redetermined to-be-executed program to obtain a corresponding split program until a specified condition is met.

8. The method according to claim 7, wherein that a specified condition is met comprises:
a difference between key values comprised in each split program is the minimum; or a quantity of times of redetermining a to-be-executed program reaches a specified quantity of times, wherein the specified quantity of times is determined based on a maximum value and an average value that are of key values in each initially determined to-be-executed program.

9. The method according to claim 1, wherein the determining key values in a plurality of to-be-executed programs comprises:
determining an encrypted key value in the plurality of to-be-executed programs;
the comparing the key value with another key value comprises:
comparing the key value with the another key value by using a confidential operation;
the redetermining correspondences between each first empty slot and the key value comprises:
redetermining the correspondences between each first empty slot and the key value by using a confidential operation; and
the splitting the key value comprises:
splitting the key value by using a confidential operation.

10. (canceled)

11. A non-transitory computer-readable storage medium, wherein the storage medium stores a computer program, and when the computer program is executed by a processor, the processor is caused to implement a program execution method, and the method comprises:
determining key values in a plurality of to-be-executed programs;
for each key value, setting a first empty slot corresponding to a key value;
comparing the key value with another key value;
redetermining, based on a comparison result, correspondences between each first empty slot and the key value;
splitting the key value based on a redetermined first empty slot corresponding to the key value, to obtain each split value corresponding to the key value, wherein a sum of each split value is the key value;
using a to-be-executed program in which the key value is located as an original program, and for each split value, replacing the key value in the original program with the split value, to obtain a split program corresponding to the original program; and
executing split programs corresponding to all to-be-executed programs.

12. An electronic device, comprising a memory, a processor, and a computer program that is stored in the memory and that is capable of running on the processor, wherein when the processor executes the program, the processor is caused to implement a program execution method, and the method comprises:
determining key values in a plurality of to-be-executed programs;
for each key value, setting a first empty slot corresponding to a key value;
comparing the key value with another key value;
redetermining, based on a comparison result, correspondences between each first empty slot and the key value;
splitting the key value based on a redetermined first empty slot corresponding to the key value, to obtain each split value corresponding to the key value, wherein a sum of each split value is the key value;
using a to-be-executed program in which the key value is located as an original program, and for each split value, replacing the key value in the original program with the split value, to obtain a split program corresponding to the original program; and
executing split programs corresponding to all to-be-executed programs.

13. The non-transitory computer-readable storage medium according to claim 11, wherein the setting a first empty slot corresponding to a key value comprises:
setting, for the key value, the first empty slot corresponding to the key value and a second empty slot used to store the key value; and
the splitting the key value based on a redetermined first empty slot corresponding to the key value comprises:
splitting the key value based on the redetermined first empty slot corresponding to the key value and the second empty slot used to store the key value.

14. The electronic device according to claim 12, wherein the setting a first empty slot corresponding to a key value comprises:
setting, for the key value, the first empty slot corresponding to the key value and a second empty slot used to store the key value; and
the splitting the key value based on a redetermined first empty slot corresponding to the key value comprises:
splitting the key value based on the redetermined first empty slot corresponding to the key value and the second empty slot used to store the key value.

15. The electronic device according to claim 12, wherein the comparing the key value with another key value comprises:
using the key values as leaf nodes of a binary tree;
using each leaf node of the leaf nodes as a to-be-compared node;
comparing two to-be-compared nodes that have a same parent node, and determining, based on a comparison result, a key value corresponding to the parent node of the two to-be-compared nodes; and
reusing the parent node as the to-be-compared node until a key value corresponding to a root node is determined.

16. The electronic device according to claim 15, wherein the determining, based on a comparison result, a key value corresponding to the parent node of the two to-be-compared nodes comprises:
using a larger value in key values corresponding to the two to-be-compared nodes as the key value corresponding to the parent node of the two to-be-compared nodes.

17. The electronic device according to claim 15, wherein the redetermining correspondences between each first empty slot and the key value comprises:
for each parent node of the binary tree, determining a layer at which a child node of the parent node is located in the binary tree, and determining, based on the layer, a threshold corresponding to the child node of the parent node; and
if a ratio of a larger value to a smaller value in key values corresponding to two child nodes of the parent node is not less than the threshold, determining key values corresponding to all leaf nodes comprised in a subtree corresponding to the parent node in the binary tree as specified key values, and resetting first empty slots corresponding to the specified key values to a key value corresponding to the parent node.

18. The electronic device according to claim 14, wherein the splitting the key value based on the redetermined first empty slot corresponding to the key value and the second empty slot used to store the key value comprises:
using the first empty slot corresponding to the key value and the second empty slot used to store the key value as available empty slots corresponding to the key value; and
splitting, based on a quantity of available empty slots corresponding to the key value, the key value into split values of the quantity, to minimize a difference between the split values split from the key value, wherein each available empty slot is used to store one split value.

19. The electronic device according to claim 12, wherein before the executing split programs corresponding to all to-be-executed programs, the electronic device is further caused to:
redetermine each split program as a to-be-executed program, and continuing to split a key value in each redetermined to-be-executed program to obtain a corresponding split program until a specified condition is met.

20. The electronic device according to claim 19, wherein that a specified condition is met comprises:
a difference between key values comprised in each split program is the minimum; or
a quantity of times of redetermining a to-be-executed program reaches a specified quantity of times, wherein the specified quantity of times is determined based on a maximum value and an average value that are of key values in each initially determined to-be-executed program.

21. The electronic device according to claim 12, wherein the determining key values in a plurality of to-be-executed programs comprises:
determining an encrypted key value in the plurality of to-be-executed programs;
the comparing the key value with another key value comprises:
comparing the key value with the another key value by using a confidential operation;
the redetermining correspondences between each first empty slot and the key value comprises:
redetermining the correspondences between each first empty slot and the key value by using a confidential operation; and
the splitting the key value comprises:
splitting the key value by using a confidential operation.
